(19) United States
(12) Patent Application Publication
(10) Pub. No.: US 2005/0098025 A1
(43) Pub. Date: May 12, 2005

(54) Control device for an electric guitar

(76) Inventor: Melvis C. Fussell, Lucas, TX (US)

Correspondence Address: Bobby D. Slaton;Jackson Walker, LLP, Suite 600, 2435 North Central Expressway, Richardson, TX, 75080, US

(21) Appl. No.: 10/702,938

(22) Filed: Nov. 6, 2003

(51) Int. Cl. G10H 1/02

(52) U.S. Cl. 84/737

(57) ABSTRACT

A sound control apparatus and system for use with an electric guitar having a body, strings extending over a portion of a front face of the body and arranged to be engaged by fingers on the playing hand of the guitarist to vibrate the strings to produce sound, the guitar further having an electrical device for controlling a quality of the sound heard as a result of playing the strings, comprising a control device adapted to couple with the electrical device in close proximity to the strings such that a portion of the control device is adjacent the strings and a portion of the control device is distant the strings, the control device is further adapted to be rotatably controlled by the guitarist fingers for effectuating a quality of the sound, whereby the guitarist controls the sound quality with a hand employed to vibrate the strings, and further comprising a restricting device coupled with the control device and cooperable therewith for preventing rotation of the control device from pressure applied from the adjacent portion of the control device.

### FIELD OF THE INVENTION

The invention relates generally to the field of musical instruments and, more particularly, to a control device for an electric guitar.

### BACKGROUND OF THE INVENTION

Electric guitars are provided with volume and tone controls on the strumming surface of the guitar usually at a position within the strumming area to allow easy access to the volume and tone control knob to effectuate volume and tone control changes during play. In the playing of electric guitars, to achieve certain effects, the guitarist must manually increases or decreases the volume or tone during the play of a musical piece thus necessitating the rotation of the volume or tone control knob with the little finger of the strumming hand while a particular note is still being emitted. For example, when attempting to effect a violin-type tone manually, the guitarist usually uses the little finger to quickly rotate the volume, from zero to maximum, and then perhaps back to zero or some point in between. Because of the close proximity of the control knobs to the strumming hand, the volume and tone control knobs are often inadvertently rotated by one or more fingers of the strumming hand.

Accessory devices have been built to facilitate this volume or tone control and prevent inadvertent changes in the volume and tone, such devices usually taking the form of foot operated devices which thereby enable the guitarist to maintain the hand in the playing position while effecting the changes of volume or tone during the play of the piece. However, the foot lacks the sensitivity of the hand in creating such an effect, particularly if a prolonged violin-type tone is desired. Furthermore, with such foot operated devices, cords, batteries, electronics, or other more complicated device are usually required.

Therefore, there is a need for a new and improved accessory for an electric guitar to provide volume and/or tone control by the guitarist while preventing inadvertent volume and/or tone control changes. There is also a need for a new and improved accessory for an electric guitar which requires no electrical connections and is readily attachable to existing electric guitars.

### SUMMARY

The present invention achieves technical advantages as an apparatus and system for providing a control vibrato device for an electric guitar that is more consistently actuated by the musician than prior such devices. An object of the invention to provide improved sound control for an electric guitar that does not require modification of existing electrical controls.

### BRIEF DESCRIPTION OF THE DRAWINGS

For a more complete understanding of the present invention, reference is made to the following detailed description taken in conjunction with the accompanying drawings wherein:

FIG. 1 illustrates a perspective view of a conventional electric guitar;

FIG. 2 illustrates hand positioning for playing the electric guitar and a knob guard in accordance with exemplary embodiments of the present invention;

FIG. 3 illustrates a knob guard for a control assembly in accordance with exemplary embodiments of the present invention; and

FIGS. 4A-4C illustrate knob guards in accordance with exemplary embodiments of the present invention; and

FIG. 5 illustrates a control knob assembly in accordance with exemplary embodiments of the present invention.

### DETAILED DESCRIPTION

The numerous innovative teachings of the present application will be described with particular reference to the presently preferred exemplary embodiments. However, it should be understood that this class of embodiments provides only a few examples of the many advantageous uses and innovative teachings herein. In general, statements made in the specification of the present application do not necessarily delimit any of the various claimed inventions. Moreover, some statements may apply to some inventive features, but not to others. Throughout the drawings, it is noted that the same reference numerals or letters will be used to designate like or equivalent elements having the same function. Detailed descriptions of known functions and constructions unnecessarily obscuring the subject matter of the present invention have been omitted for clarity.

The stratocaster type guitar was introduced in the early 1950's and is still made today. It is one of the most popular electric guitars in the world. The volume knob on a stratocaster, for example, is located just below the string on the front face of the base for fast easy access during play of the guitar. By placing the little finger under the volume knob the guitarist can turn the volume up and down, for effecting swells, while picking the strings. Volume swells make a kind of “wah-wah” sound that is popular in rock and other styles of music today. However, easy access also leads to accidentally movement of the volume knob in which the volume is turned up or down, or turning the volume off all together. Other control knobs, such as for tone control, can similarly be accidentally moved during play.

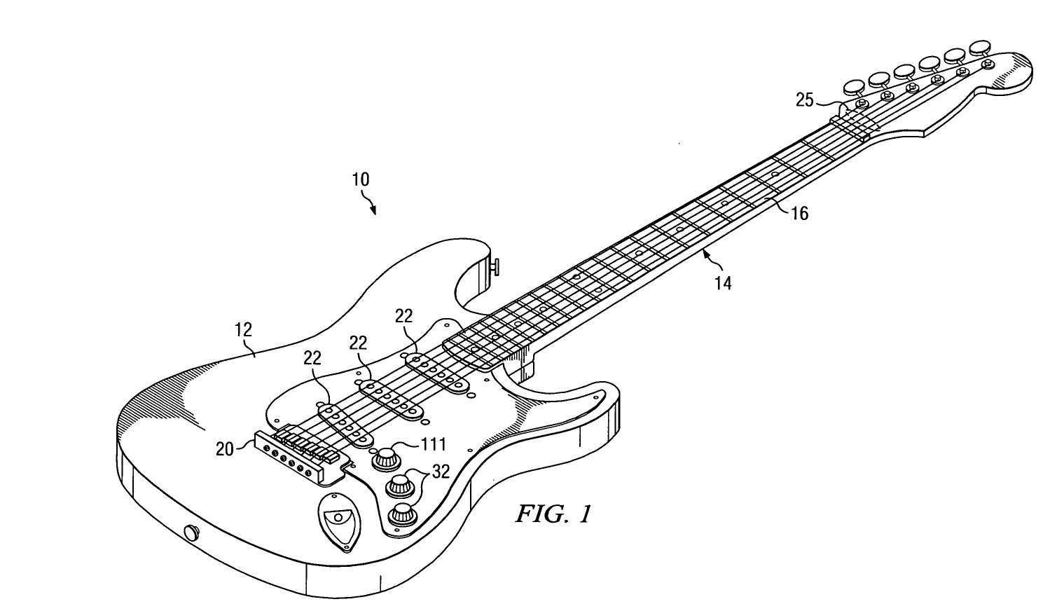

An electric guitar is shown in FIG. 1, in which the guitar 10 includes a body, a neck 14 disposed in the manner shown relative to the body, and a head formed at the free end of the neck 14 (not shown). A plurality of strings 25 are stretched over the neck 14 and a portion of the body face 12 and are in substantially parallel relationship relative to each other. More specifically, the strings 25 are stretched between the head and a tail piece or bridge 20 mounted on the body face 12 and pass over the fingerboard 16. The strings 25 are connected to pick-ups 22, pick-ups are well known to those skilled in the art. Additionally mounted on the body face 12 are volume 111 and tone 32 controls associated with the pick-ups and amplification system of the electric guitar. The above-described construction is common to those of conventional electric guitars and electric guitars systems.

Generally, the volume and tone control assemblies comprise potentiometers mounted within the body from the front in a conventional manner. The potentiometers have control knobs extending through the face 12 in a manner such that they can be adjusted, where the volume control knob is noted as item 111 and the tone control knobs are noted as items 32. Adjustment of the volume and tone is typically done by the guitarist using one finger to rotate the control knob 111, 32.

An embodiment of the present invention provides a fence or guard extending around the portion of a conventional volume knob between the knob 111, 32 and strings 25. The guard fits closely to the knob while still leaving easy access to the bottom portion of the knob so that it may still be rotatably controlled by the finger during play. Thus, volume swells are still easily effectuated with the little finger.

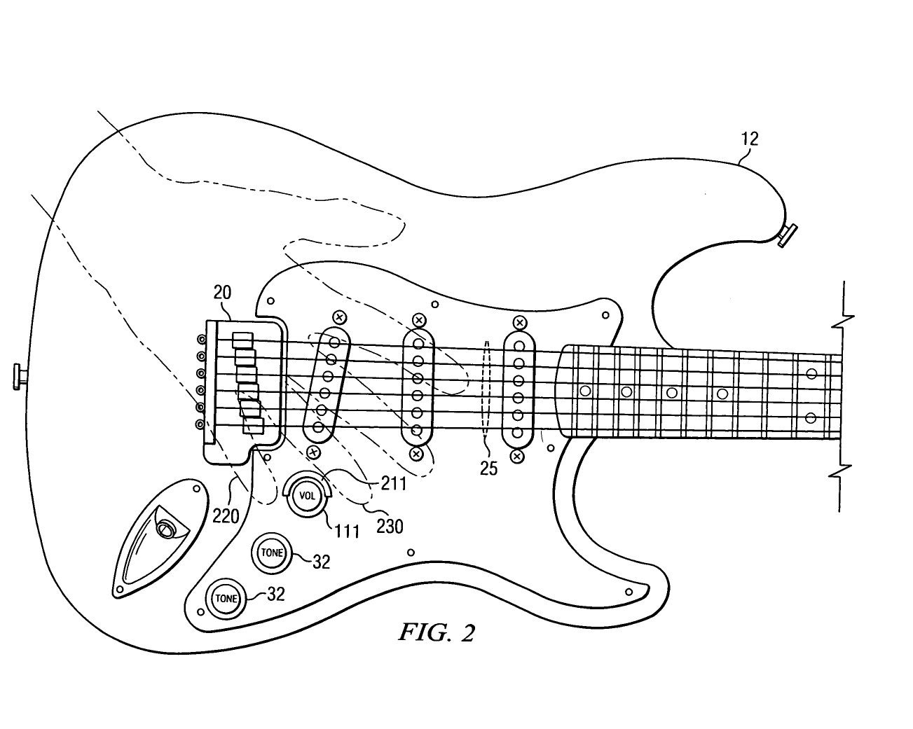

A specified construction in accordance with exemplary embodiments of the present invention will be better understood from the illustration given in FIG. 2. FIG. 2 illustrates the placement of a guitarist's hand (shown in broken lines) in relation to the strings 25 and the volume control knob 111 and tone control knobs 32. Also, illustrated is a knob guard 211 in accordance with exemplary embodiments of the present invention. Note the knob guard 211 is only shown provided with the volume control 111 however, it can also be provided with the tone control knobs 32. The guitarist conventionally operates of the volume control knob 111, for example, by rotating the knob with the little finger 220 from the side of the knob opposite from the strings 25 (hereinafter referred to as the underside).

The guard 211 is provided partially around an outer portion of the knob, on the side most near the strings 25 (hereinafter referred to as the topside), extending upward from the body face without effecting the conventional rotational movement of the knob (although effecting how the knob can be rotated). The guard 211 is provided in such a manner that the guitarist can rotate the volume knob 111 from the underside while preventing inadvertent topside movement of the knob 111 (by other fingers 230 of the strumming hand, for example). The guard 211 is provided with a contour substantially the same as the topside contour of the volume knob 111 so to minimize the area consumed. The guard 211 can be secured directly to the guitar face 12 or secured with and/or to the knob assembly (further described below).

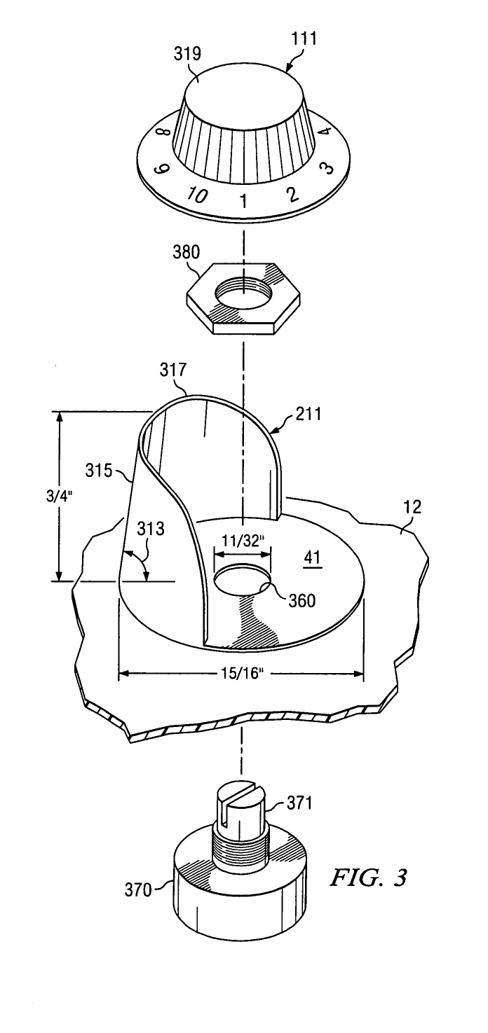

Referring now to FIG. 3 there is illustrated the guard 211 in relation to a conventional control assembly in accordance with exemplary embodiments of the present invention. As above-mentioned, the volume control assembly comprises a potentiometer 370 mounted within the body 12 extending through the face 12 in a conventional manner. For ease of play, it is important that the angle 313 of the outer guard wall 315 be less than approximately 70 degree from the face 12. Further, the top most portion 317 of the guard should be approximately the same height from the face 12 as the top most portion 319 of the control knob 111.

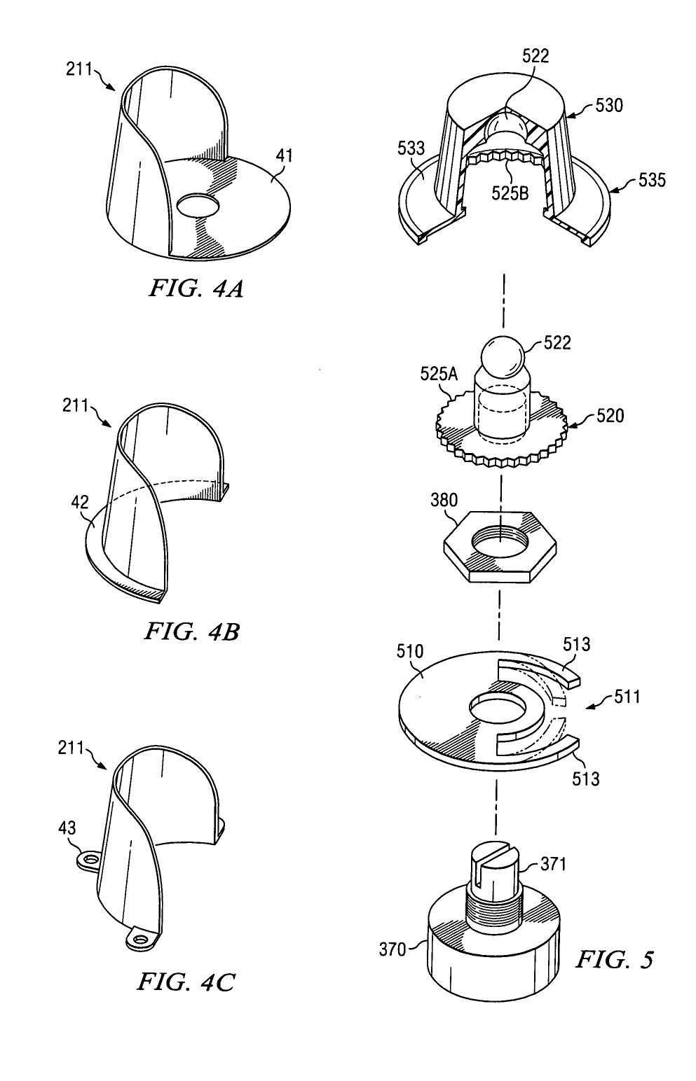

The control assembly is typically comprised of a volume knob 111, mounting nut 380, and potentiometer 370. More specifically, the potentiometer 370 is extended through a hole 360 in the front face 12 and is secured by application of the mounting nut 380. In one embodiment, the guard 211 is secured to the face 12 via the mounting nut 380. That is, the guard 211 is configured with a lower lip 41 (shown in FIG. 4A) which sits flush on the face 12. The lip 41 further has a hole or opening of such a size to enable the potentiometer 370 to fit therethrough, wherein application of the mounting nut 380 to the potentiometer 370 also secures the guard 211 to the body face 12. Thus, the guard 211 is secured and provided around a portion of the volume knob 111 in such a manner without effecting the conventional rotational movement of the knob.

In another embodiment, the guard 211 includes a lip 42 (shown in FIG. 4B) provided around the bottom edge of the guard 211 for seating on the body face 12. The lip is secured to the body face 12 with a securing material, such as glue. In this configuration, the guard 211 can be installed without disassembling an installed control assembly. In a further embodiment, the guard 211 includes securing wings 43 (shown in FIG. 4C) provided around the bottom edge of the guard 211. The wings 43 are provided with a hole or slot such that a securing device, such as a screw, can be applied through the hole or slot and into the body face 12. This embodiment also enables application of the guard 211 without disassembly of an installed control assembly. FIG. 4C shows three wings 43 however, more or less wings can be used.

Referring now to FIG. 5 there is illustrated a further embodiment of a knob control assembly in accordance with exemplary embodiments of the present invention. The assembly includes a pivoting knob 530, a knob spindle 520, and a control washer 510 all of which are mountable on a convention guitar. More specifically, the control washer 510 is provided over the spindle of the conventional potentiometer 370 and rests on the guitar face 12 secured by the conventional mounting nut 380. The inner portion of the knob spindle 520 (shown in broken lines) is adapted to fit securely on the potentiometer spindle such that rotation of the knob spindle 520 effectuates rotation of the potentiometer spindle. Further, the knob spindle 520 has an outer circular portion 525A which includes teeth or gear spines around the circumference and a pivot shaft extending perpendicularly from the circular portion 525A. The shaft includes an end which is adapted to couple to the pivoting knob 530, here it is shown with a spherical end which snaps into a corresponding spherical portion of the pivoting knob 530.

As illustrated, the pivoting knob 530 is formed with an inner portion which conforms to the spherical end of the spindle 520 such that it is fitted to enable the knob 530 to be held in place yet enabled to move freely about the pivot shaft (the corresponding spherical shaped portions are indicated as item 522). The free movement includes a spinning motion about an axis perpendicular to the spindle outer circular portion 525A. The knob 530 inner portion further includes a circular geared portion 525B which corresponds to the geared portion 525A of the spindle 520 such that, when the two geared portions are engaged, turning the knob 530 effectuates turning of the potentiometer 370 spindle. However, while the knob 530 is at rest in a normal position on the spindle 520, the geared portions are not engaged and, thus turning of the knob 530 does not turn the potentiometer 370 spindle. The geared portions are engaged by moving the knob 530 in a “tilt” or “wobble” type motion on the spindle pivot shaft.

The control washer 510 includes an opening 511 which is cooperable to enable the knob 530 to be lifted in a “wobble” type motion in which other portions, particularly the opposite side, of the control washer 510 does not allow the knob 530 to be lifted. Further, the control washer 510 is adapted to receive the knob 530 for maintaining it in a normal resting position. More specifically, the knob base portion 533 includes an inner portion (shown in dashed lines at item 535) having a radius substantially that of the control washer 510 enabling the knob 530 to seat over the control washer 510. In operation, the opening 511 is positioned opposite from the strings 25 of the guitar such that control changes via the knob 530 can only be effectuated from movement of the fingers from that portion of the control knob 530. Thus, inadvertent bumping of the knob 530 from side portions other than the opening side portion does not effectuate a rotation of the potentiometer spindle.

The control washer 510 is adapted with a pair of spring arms 513 to selectively provide for knob tilting by the guitarist. In operation, the spring arms 513 collapse when pressure is applied to the base portion 533 of the knob 530 from the direction of the opening 511. With the spring arms collapsed, the knob 530 tilts slightly engaging the geared portion of the knob 530 and the spindle 520. Pressure from other directions does not engage the spring arms 513 and, thus does not effectuate engagement of the gears.

Although exemplary embodiments of the invention are described above in detail, this does not limit the scope of the invention, which can be practiced in a variety of embodiments.

1. A sound control system for use with an electric guitar having a body, strings extending over a portion of a front face of said body and arranged to be engaged by fingers on the playing hand of a guitarist to vibrate the strings to produce sound, said guitar further having an electrical device for controlling a quality of the sound heard as a result of playing said strings, said system comprising:
an actuator adapted to couple with said electrical device in close proximity to said strings such that a portion of said actuator is adjacent said strings and a portion of said actuator is distant said strings, said actuator is further adapted to be rotatably controlled by said guitarist fingers during play for effectuating a quality of said sound; and
a restricting device coupled with said actuator and cooperable therewith for preventing rotation of said actuator by pressure applied to said adjacent portion of said actuator.

2. The sound control system of claim 1, whereby the guitarist manually controls said sound quality with the hand employed to vibrate the strings, said restricting device effectuating rotation of said actuator only from pressure applied to said distant portion of said actuator.

3. The sound control system of claim 1, wherein said actuator is a circular-shaped knob and said restricting device is a guard coupled in close proximity with said knob between said string and said adjacent portion, said guard having a curved surface with a radius substantially the same as that of said knob with an angular tilt of less than 70 degrees referenced from said body front face.

4. The sound control system of claim 3, wherein said guard further has a skirt extending outwardly from said surface and adapted for fixedly coupling to said guitar front face.

5. The sound control system of claim 1, wherein said actuator includes a rotatable shaft extendable through said front face, wherein rotation of said shaft effectuates said sound quality and further including a knob coupled with said rotatable shaft, said knob is operable to effectuate rotation of said shaft responsive to rotation thereof using said guitarist fingers.

6. The sound control system of claim 5 further including a means for preventing rotation of said knob from said adjacent portion of said knob.

7. The sound control system of claim 5, wherein said knob is adapted to be engageable with said shaft for rotation thereof from a touching of said guitarist fingers on said distant portion of said knob, wherein rotation of said shaft from touching of said guitarist fingers on said adjacent portion of said knob is precluded.

8. The sound control system of claim 7, wherein said knob has an engagement portion corresponding to an engagement portion associated with said shaft, said engagement portions are provided such that while said knob rests normal to said shaft said engagement portions are disengaged and while said knob is tilted said engagement portions are engaged.

9. The sound control system of claim 8 further including a control washer adapted to receive said knob and maintain said knob in a normal position, said control washer further adapted to enable a tilting of said knob via touching from a selected direction.

10. The sound control system of claim 9, wherein said control washer includes a spring device which enables a tilting of said knob.

11. The sound control system of claim 5, wherein said knob includes:
a control washer;
a shaft extension having a first end adapted for securing to said shaft and a second end adapted to rotatably couple to a cap, said first end further adapted with a outer circular geared portion;
said cap having an interior for fitting over said shaft extension and having an inner circular geared portion corresponding to said shaft extension outer circular geared portion, said control washer is adapted to receive said cap in a normal position and further adapted with a spring device which enables tilting of said cap relative to said shaft extension, said outer circular geared portion and said inner circular geared portion are provided such that while said cap rests normally said geared portions are disengaged and while said cap is tilted said geared portions are engaged.

12. An apparatus for use with an electric guitar having a body, strings extending over a portion of a front face of said body and arranged to be engaged by fingers on the playing hand of a guitarist to vibrate the strings to produce sound, said guitar further having a potentiometer for controlling a quality of said sound heard as a result of playing said strings, said potentiometer having an actuator provided in close proximity to said strings and adapted to be rotatably controlled for effectuating said sound quality, said apparatus comprising:
a control washer;
an actuator knob having an inner portion adapted to couple with said actuator and further adapted to rest normally about said control washer, said control washer and said actuator knob are cooperable for rotating said actuator responsive to a touching of said guitarist fingers from a selected side of said actuator relative to said strings.

13. The device of claim 12, wherein said control washer includes a spring device adapted to enable said actuator knob to be tilted from said normal position, wherein said actuator knob is adapted to rotate said actuator only in a tilted position.

14. The device of claim 12, wherein said actuator knob includes:
a spindle having a first end adapted for securing to said actuator and a second end adapted to received a cap, said spindle further having a geared portion;
said cap having an interior adapted for rotatably coupling to said spindle, said interior further having a geared portion corresponding to said spindle geared portion, said control washer includes a spring device which enables tilting of said cap from pressure applied in a selected direction, said spindle geared portion and said cap geared portion are provided such that while said cap rests normally said geared portions are disengaged and while said cap is tilted said geared portions are engaged.

15. The device of claim 14, wherein said spring device is provided on said control washer for application opposite from said strings such that rotation of said actuator is effectuated by firstly tilting said cap from normal and secondly rotating said cap.

16. A replacement knob for a volume control of an electric guitar, wherein the volume control includes a potentiometer having a rotatable shaft and a retainer for coupling said potentiometer to said guitar such that said rotatable shaft extends through the face of said guitar, said replacement knob comprising:
a control washer adapted to rest flush on said guitar face;
a spindle having a first end adapted for securing to said rotatable shaft and a second end adapted to received a cap, said spindle further having a geared portion;
said cap having an interior adapted for rotatably coupling to said spindle and further adapted to rest normally flush with said guitar face about said control washer, said interior further having a geared portion corresponding to said spindle circular geared portion, said control washer includes a spring device which enables tilting of said cap, said spindle geared portion and said cap geared portion are provided such that while said cap rests normally said geared portions are disengaged and while said cap is tilted said geared portions are engaged.
